(19) United States
(12) Patent Application Publication
(10) Pub. No.: US 2005/0159984 A1
(43) Pub. Date: Jul. 21, 2005

(54) Medical data management system

(76) Inventors: Hirofumi Hirano, Kagoshima-shi (JP); Fuminori Muranaga, Kagoshima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/936,683

(22) Filed: Sep. 9, 2004

Related U.S. Application Data
(60) Provisional application No. 60/501,835, filed on Sep. 11, 2003.

(51) Int. Cl. G06F 17/60

(52) U.S. Cl. 705/3

(57) ABSTRACT

A medical data management system wherein patients, doctors, medical professionals except doctors, and medical institutions are registered as members, and log in using an ID and login authentication means for each member to register and preserve medical data for effective use thereof. The system comprises a management file associated with each individual medical data, in which access authority of a member to enable the member to access the medical data is recorded; and access authority addition authentication means to enable recording additionally access authority of a member in the management file, and the access authority addition authentication means exists for each patient member.

### CROSS-REFERENCE TO RELATED APPLICATIONS

The present application claims priority from U.S. Provisional Patent Application No. 60/501,835 filed on Sep. 11, 2003, which is herein incorporated by reference.

### BACKGROUND OF THE INVENTION

1. Field of the Invention

The present invention relates to a medical data management system which allows medical professionals, patients, and researchers to share medical data efficiently and securely, enables the cooperative utilization of medical data in the fields of medicine, medical research, and medical economy, and enables selecting and preserving important medical data.

2. Description of the Related Art

Conventionally, medical data has been recorded on a paper, or an X-ray image, CT/MRI, or the like preserved on a film, and providing medical data to other medical professionals is usually performed by providing the paper or film.

Although electronic medical record systems that have been being introduced enables electronic storage and browsing of medical data, their objective is to digitize conventional paper medical records and enable the sharing of information among doctors, and those systems are designed such that doctors take a center role in terms of accumulation, storage and browsing of medical data.

Meanwhile, remote diagnosis systems are starting to come into practical use between particular institutions.

Moreover, a method of sharing medical information of individuals that is a database of medical records by a plurality of hospitals and a database terminal for the medical information of individuals are disclosed in, for example, Japanese Patent Application Laid-open Publication No. 2001-297153.

Since a conventional electronic medical record system is a system where medical professionals take a center role, the further storing of medical data whose compulsory preservation period has elapsed is determined arbitrarily by the medical institution, and thus there is the problem that the medical data is likely to be lost regardless of the wishes of the patients.

Further, those systems lack the point of view that patients take a center role in deciding provision of information to the medical research field thereby contributing to the development of medicine and medical business.

Yet further, there exists no means for users who share medical data to preserve individually the medical data according to their respective degrees of importance and also no means to split the preservation cost.

Also, the conventional remote diagnosis system has no means to realize a secure remote diagnosis of high quality over a wide area network as a medical business.

Moreover, although Japanese Patent Application Laid-open Publication No. 2001-297153 has proposed a second password as means for a doctor and a patient to share medical data, no means is provided to manage access authority on a per medical data basis. Also, if the patient changes the second password, a situation occurs where the hospital side can not access all data of the patient including medical data used as the base of diagnosis, and further if the patient is unconscious, nobody can access the medical data. Thus, it is difficult to achieve realistic and rational management.

### SUMMARY OF THE INVENTION

In view of the above problems, an object of the present invention is to provide a medical data management system which comprises a medical data access authority management means for patients, doctors, medical professionals except doctors (hereinafter, called paramedics), researchers, medical institutions, and the like to efficiently and securely share electronically stored medical data via communication means such as the Internet, thereby achieving both the disclosure of medical data to the patients and maintenance of the medical data by the medical institutions under the Medical Practitioners Law and Medical Service Law and enabling effective remote diagnosis, selecting and preserving important medical data during a time period specified by members including its patient member, and the use of medical data in the fields of medical research and medical economy.

In order to solve the above and other tasks, one embodiment of the present invention is a medical data management system wherein patients, doctors, medical professionals except doctors, and medical institutions are registered as members, and log in using an ID and login authentication means for each member to register and preserve medical data for effective use thereof, the system comprising a management file associated with each individual medical data, in which access authority of a member to enable the member to access the medical data is recorded; and access authority addition authentication means to enable recording additionally access authority of a member in the management file, wherein the access authority addition authentication means exists for each patient member.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a view showing the configuration of a medical data management system according to the present invention;

FIG. 2 is a view showing an example of a member information file;

FIG. 3 is a view for explaining a medical data management file;

FIG. 4 is a view showing an example of an after-logging-in initial screen;

FIG. 5 is a view showing an example of a patient-to-be-examined data list screen;

FIG. 6 is a view showing an example of a medical data detail browse screen (for doctors);

FIG. 7 is a view showing an example of a medical data detail browse screen (for patients);

FIG. 8 is a view showing an example of a medical data access authority addition restriction setting screen;

FIG. 9 is a view for explaining the creation of a one-time password;

FIG. 10 is a view for explaining an on-consulting access authority addition restriction process;

FIG. 11 is a view for explaining an on-remote-diagnosis access authority addition restriction process;

FIG. 12 is a view for explaining the concept of a process of determining a member to be responsible for storage of medical data;

FIG. 13 is a view for explaining a process of determining a member to be responsible for storage of medical data and deleting the medical data; and

FIG. 14 is a schematic view showing medical data use functions executable by each type of member.

### DETAILED DESCRIPTION OF THE INVENTION

At least the following matters will be made clear by the explanation in the present specification and the description of the accompanying drawings.

A first aspect of the present invention is a medical data management system wherein patients, doctors, medical professionals except doctors, and medical institutions are registered as members, and log in using an ID and login authentication means for each member to register and preserve medical data for effective use thereof, the system comprising a management file associated with each individual medical data, in which access authority of a member to enable the member to access the medical data is recorded; and access authority addition authentication means to enable recording additionally access authority of a member in the management file, wherein the access authority addition authentication means exists for each patient member.

In this medical data management system, medical data generated by a doctor examining or the like is provided to the present system by the doctor member, a paramedic member, a patient member, or the like, and the provided medical data is individually managed by the management file.

The members are classified into various member groups according to a relationship with the medical data, and registered. Each member is granted an ID and, for example, a login password as login authentication means so that each member logs into the system using the granted ID and login password.

In order to control efficiently each member's authority of access to medical data, the management file for the medical data and the access authority addition authentication means for each patient member are provided. By these two means, practical management of access authority is achieved.

That is, authority of access to medical data is recorded in the management file of the medical data, and the access authority addition authentication means is required in order to record access authority additionally in the management file.

Hence, the members whose access authority is recorded in the management file are allowed to access the medical data, and acquiring new authority of access to the medical data is performed by a doctor member or the like acquiring the access authority addition authentication means disclosed by the patient member and adding access authority to the management file.

The above login authentication means and access authority addition authentication means are any of information stored and managed as a password by an individual and inputted each time, information recorded on a storage medium such as a magnetic card or an IC card, one created from intrinsic biological information of an individual such as a fingerprint or a retina pattern, and the like.

As a result, medical data conventionally recorded on papers or films are stored as electronic data and can be shared across temporal and spatial distances.

Although conventionally doctors take a center role in accumulation, storage and browsing of medical data, in the present aspect patients can participate as members in accumulation, storage and browsing of medical data, and authority to allow adding authority of access to medical data is possessed by the patient members. Hence, the patient members take a center role in use of the medical data.

However, because members whose access authority is recorded in the management file of the medical data are persons having authority of access to medical data, authority of access to medical data used once in diagnosis that is the base of diagnosis is ensured for the doctor member. Note that functions that can be performed on medical data differ depending on the type of member.

The medical data comprises, for example, indefinite-form data and comments (including diagnosis comments, remote diagnosis comments, etc.) registered by each member. The indefinite-form data is a single one of the following or any combination thereof: for example, text data such as the medical history of a patient member, prescriptions, remarks, diagnoses, and comments; numerical data such as clinical examination; image data such as electrocardiograms, X-ray photographs, MRI, and CT; video; voice; information expressed in XML (eXtensible Markup Language) or the like; and secondary medical data obtained by performing process such as change of color tone and thickness on images.

The “management file for managing medical data” is for storing information about the management of medical data, and more than one management file exists for each medical data. The files may exist independent of the medical data or integrated with the medical data or exist as a database.

Note that the “doctor” is a person having a license to conduct diagnosis on the basis of the law and includes a dentist and the like.

Information included in the management file is, for example, the place where the medical data is stored, the IDs of members having access authority, date and time when the access authority has been obtained, the IDs of members having added their access authority, information about the access authority history such as passage up to adding access authority, restriction of access authority addition, the declaration of the medical data being unnecessary, the scope of disclosure for the purpose of research of the medical data, the amount of the medical data, and the like.

The record of access authority of each member in the management file is achieved by recording the member's ID in an access authority record area of the management file, and when a logged-in member requests access to medical data, the medical data management system searches the management file of the medical data, the access to which has been requested, and allows the members whose IDs are recorded in the access authority record area to access the medical data. Note that in order to protect the privacy of the members, the member information, the medical data, the medical data management file, and the like to be recorded in the medical data management system may be encrypted and recorded.

A second aspect of the present invention enables access of another member to medical data by a function for a member having his access authority already recorded in the management file of the medical data to add access authority of the another member to the management file.

For example, where a doctor member already has authority of access to medical data of a patient member, the addition of another member's authority of access to the medical data is enabled by providing functions that the doctor member can use when having logged into the medical data management system, such as a function to select the medical data, a function to confirm whether access authority of the another member exists in the access authority record area of the medical data management file, and a function to add an ID as new access authority to the management file.

By this means, for example, in remote diagnosis, it becomes possible to give the authority of access to particular medical data to a person requested for remote diagnosis, and thus, remote diagnosis can be securely conducted over a wide area network.

If a member exists who has obtained authority of access to medical data in an unauthorized manner, the patient member can capture the member having unauthorized access authority by searching access authority recorded in the medical data management file, and if unauthorized access is found, the system administrator may delete the access authority of the member performing unauthorized access from the medical data management file depending on the wish of the patient member.

A third aspect of the present invention is configured to have a function to enable each patient member to register his own medical data by himself and a function to record automatically each patient member's own access authority in the management files of all his medical data including medical data registered by other members, if any, such that each patient member can not only always access his own medical data but also disclose the medical data to others.

Because all medical data are created on the basis of the presence of a patient member, by providing, for example, a function to record automatically the ID of a patient member in the access authority record area of the management file in response to creation of medical data, the patient member is always ensured authority of access to his own medical data.

A fourth aspect of the present invention allows a researcher member to participate and is configured to have a function to record the scope of medical data approved by a patient member in the management file of the medical data so as to open medical data of the approved scope to the researcher member.

The function is realized by the present system comprising, for example, functions for a patient member, who has logged into the medical data management system, to select medical data to allow to be disclosed and to specify the scope of disclosure of personal information of the patient member such as sex and age associated with the medical data and functions to record the selection results in the management file and for the researcher member to extract intended medical data using conditional search. In this case, the patient member can ask for payment for use of his medical data in research.

By this means, patients can take a center role in deciding provision of information to the medical research field thereby contributing to the development of medicine and medical business. Because medical data comprises data registered by the patient member, and a plurality of doctor members and paramedic members, there may be provided a function to have approval/disapproval of the disclosure of the medical data reflect these registrants' wills about approval/disapproval of the disclosure.

A fifth aspect of the present invention comprises a function to determine a member to be responsible for storage of medical data depending on order of degrees to which the medical data is needed by the members whose access authority is recorded in its management file, and if the member responsible for storage abdicates that responsibility, to transfer that responsibility to a candidate for a next member responsible for storage, and if finally all members abdicate the storage responsibility, to delete the medical data.

The function is realized by comprising, for example, a function to repeat the steps of sorting members having access authority listed in the medical data management file according to the member type and determining an order of priorities of members to be responsible for storage; determining a member having the highest priority to be the responsible-for-storage member and recording in the management file; notifying to the responsible-for-storage member determined; the notified responsible-for-storage member registering whether to continue to be responsible for storage in the medical data management file; and if the responsible-for-storage member abdicates being the responsible-for-storage member, determining the next responsible-for-storage member according to the order of priorities, and functions to monitor whether a responsible-for-storage member exists and, if no responsible-for-storage member exists, to delete the medical data.

As a result, as long as any of members having access authority as well as the patient member acknowledges the necessity thereof, the medical data can be stored on the medical data management system. Hence, a situation can be avoided where the medical institution determines the discard of the medical data unilaterally. Furthermore, if all members abdicate the responsibility to store the medical data, which means that no member needs the medical data, the medical data will be deleted. Thus, unnecessary medical data is not accumulated on the medical data management system, the storage of medical data depending on its degree of importance is carried out.

Here, as means for a member to automatically avoid becoming a responsible-for-storage member, by setting beforehand so as to abdicate automatically storage responsibility for all medical data, the manual discard of medical data can be avoided.

In the foregoing case, if a function not to abdicate automatically storage responsibility of the responsible-for-storage member for important medical data when an important flag is set for the data is added, the risk of losing the important medical data by mistake can be avoided.

A sixth aspect of the present invention further comprises a function to search automatically for a member responsible for storage for each medical data and to calculate the total amount of stored medical data for each member; and a function to enable charging for the calculated total amount.

For example, by providing a function to search all medical data management files for responsible-for-storage members after each time period determined by the management administrator of the medical data management system and tally the amount of medical data recorded in the medical data management files and calculate the total amount of medical data of which each member is responsible for storage, fees can be decided. In this case, not only the responsible-for-storage members when tallied but also the other members having authority of access to the medical data may be charged.

A seventh aspect of the present invention is configured to enable each patient member to change the access authority addition authentication means so as to prevent a doctor member who diagnosed the patient member in the past from accessing medical data of the patient member without a restriction.

A patient member is recognized as such by the medical data management system when logging therein. For example, where an access authority addition password is used as the access authority addition authentication means, this system may require an access authority addition password of the patient member, and after the system confirms the access authority addition password used, the patient member can change it to a new access authority addition password.

As described above, the access authority addition password can be changed freely by the patient member himself, and after the access authority addition password is changed, access authority cannot be added with the old access authority addition password. However, there is no impact on the access to the medical data of the members having their access authority registered already in the management file.

Hence, without a situation occurring where a doctor member cannot access medical data as a diagnosis base, the medical data management system taking into account privacy of the patient members as well is established.

An eighth aspect of the present invention further comprises a warning setting function for a patient member to set, for his own medical data designated by the patient member, such that, when another member adds authority of access to the medical data, the system warns the another member to the effect that his action will be notified to the patient member and after the action of the another member, records and notifies the action of the another member to the patient member.

This function is realized by the steps of, for example, after logging into the medical data management system, a patient member selecting medical data to be protected; recording it in the management file of the selected medical data that a warning has been set; searching the medical data management file when another member tries to add access authority; issuing the warning to the member trying to add access authority if a warning is set in the management file; the member trying to add access authority deciding on a process in response to the warning; and if the process is to add access authority, adding access authority and recording the member in the management file and notifying the patient member of a member having the access authority added (e.g., a person to be referred the patient to in remote diagnosis) and the member having done it (e.g., a person to refer the patient in remote diagnosis).

By this means, morals of the doctor members and paramedic members in handling medical data of the patient members are heightened thereby contributing to privacy protection of the patient members.

A ninth aspect of the present invention further comprises a function for a patient member to register disposable authentication means to allow only once another member to add authority of access to his medical data designated by the patient member, and the system is configured to require another member trying to add authority of access to the medical data to input the disposable authentication means.

This function is realized by the steps of, for example, after logging into the medical data management system, a patient member selecting target medical data; recording it in the management file of the selected medical data that requiring disposable authentication means when a member tries to add access authority is set; searching the management file of the medical data when another member tries to add access authority; requiring disposable authentication means of the person trying to add access authority if requiring disposable authentication means is set in the management file; the person trying to add access authority entering disposable authentication means in response to the requiring; confirming whether the disposable authentication means entered is valid; if valid, adding access authority and recording the person in the management file; and rendering the used disposable authentication means invalid hereafter. Thereby, a function to disclose medical data wherein the patient can take a center role can be achieved.

For example, the disposable authentication means of a patient member is created by the patient member entering a request to create disposable authentication means after logging into the medical data management system through a cellular phone, a computer terminal, or another device to connect to the Internet, and the patient member can arbitrarily decide a period of validity for when it is not used.

Means to deliver the disposable authentication means created by the patient member to the user can be by telling verbally, presenting through display on the screen of the cellular phone, printing on a ticket, or the like.

In case the ticket having the disposable authentication means written thereon is lost, the system preferably has a function for the patient member to invalidate the disposable authentication means after logging into this system through a computer terminal or a cellular phone.

Here, the “disposable authentication means” is any of information stored and managed as a password by an individual and inputted each time, information recorded on a storage medium such as a magnetic card or an IC card, one created from intrinsic biological information of an individual such as a fingerprint or a retina pattern, and the like.

===Preferred Embodiment of the Invention===

A medical data management system of the present embodiment is based on a computer system where terminals installed in medical institutions, homes, research facilities, and the like, and a medical data management server are connected via communication means such as the Internet or dedicated lines. In the medical data management system, patients, doctors, paramedics, researchers, and medical institutions are members classified into the groups, and medical data generated by doctors examining patients and the like are shared by the members with independent access authority, thereby enabling remote diagnosis with maintaining privacy of the patients and enabling data storage for a time period desired by a person having access authority, thus utilizing the medical data in the field of medicine. An embodiment of the present invention will be described below, but the present invention is not limited to this.

First, the outline of the main part of the medical data management system according to the embodiment of the present invention will be described. The medical data management system of the embodiment is realized as a computer network and programs that enable the members to utilize medical data registered and stored on a communication network, over the communication network such as the Internet or dedicated lines.

The members include patient members, doctor members, medical professional members except doctors (for example, nurses, radiological technologists, etc., called paramedic members hereinafter), medical institution members (for example, hospital members), and researcher members. The members log into the medical data management system of the embodiment via the network by using their respective IDs and login authentication means. Note that the types of members are not necessarily limited to the present embodiment.

Data such as inspection images that is generated by medical practice on patient members, and data about injuries and diseases of patient members obtained by themselves (for example, photographs of burns taken by themselves) are called medical data. Personal medical data is his own medical data of a patient member, and includes data that is generated by the patient member consulting a doctor, data created by themselves, and the like.

In the medical data management system of the present embodiment, functions usable by members are limited for each member type, and functions usable by each type of member may be displayed as function buttons in a global menu for the type of member displayed after logging in.

The doctor members, paramedic members, and patient members can register medical data in the medical data management system of the present embodiment.

The medical data registered are each provided with a management file, and with access authority of members being recorded in an access authority record area of this management file, only the members having access authority recorded can access the medical data.

Access authority addition authentication means is provided as means for members involved in medical practice (doctor members and paramedic members) to obtain authority of access to the registered medical data, and is managed by the patient member.

The patient member discloses the access authority addition authentication means to a doctor member or a paramedic member when consulting, and after the doctor member or paramedic member enters the access authority addition authentication means of the patient member into the medical data management system, a state of being usable for medical examination (hereinafter called “medical examination mode”) is set up. Thus, the doctor member or paramedic member can add access authority to the medical data management file.

Authority of access to the medical data newly registered in the medical examination mode is granted to not only the doctor member or paramedic member but also to the patient member on the basis of the principle that the patient member himself has the highest right to the medical data.

Note that the patient member can register only his personal medical data and does not need to enter the access authority addition authentication means, and that authority of access to the medical data registered by the patient member is at first granted to only the patient member. In the medical data management system of the present embodiment, authority of access to medical data transferred from another database and stored is at first granted to only the patient member.

If a patient member having medical data registered in the medical data management system goes to another medical institution and provides the access authority addition authentication means to another doctor member or paramedic member, the another doctor member or paramedic member can obtain authority of access to the medical data already registered and stored.

Furthermore, because the access authority addition authentication means is managed by the patient member, and changeable by the patient member, if the patient member changes it, the doctor member or paramedic member cannot newly obtain authority of access to the medical data that he does not have, using its access authority addition authentication means that he became aware of in the past.

Note that even if its access authority addition authentication means is changed, members can still access medical data to which they have already obtained authority of access. Thus, the members are ensured authority of access to medical data obtained by them rightfully. With this function, for example, doctor members will not be deprived unilaterally by patient members of authority of access to medical data as a diagnosis base.

In the medical data management system of the present embodiment, where a patient member cannot make a suitable judgment or do processing because of being an infant or ill, a rightful person with parental authority or guardian may be allowed to exercise the patient member's right and obligation for the patient member.

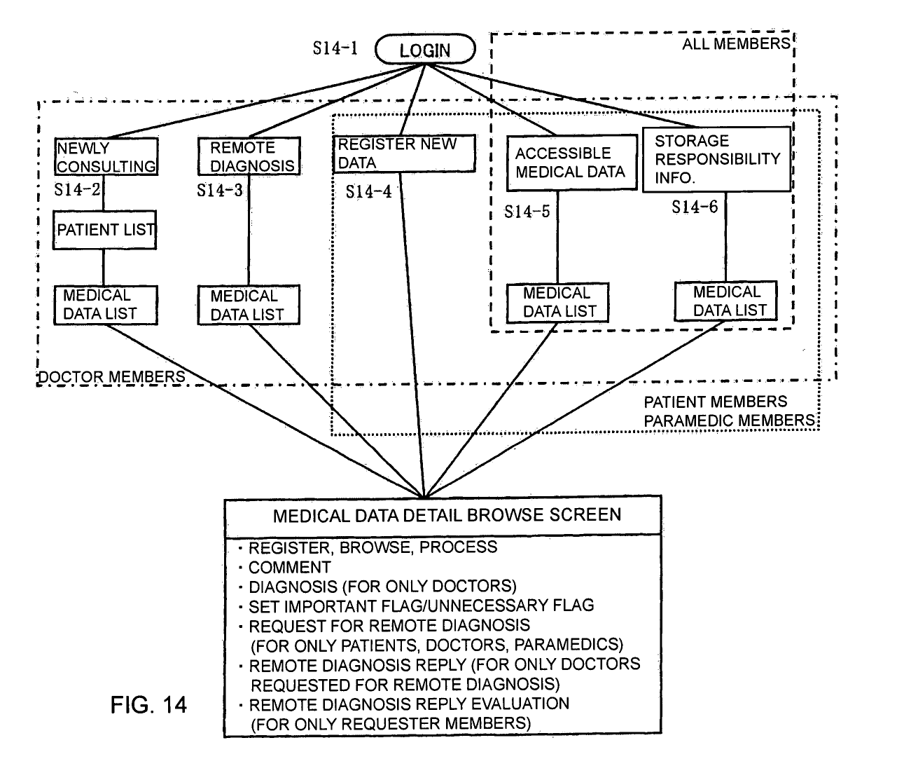

For the medical data management system of the present embodiment, an example of functions executable by each type of member and their outline will be described with reference to FIG. 14.

A doctor member can register, browse, and process medical data, and can register diagnosis comments, request remote diagnosis, and take on remote diagnosis. A patient member can register, browse, and process medical data, and can request remote diagnosis. A medical institution member (hospital member) is an institution member which performs administration of affairs such as reception of patient members, and may be a cost bearer in the case where the medical data management system of the present embodiment is used as electronic medical records in the medical institution. A researcher member can search, browse, and process only medical data that a patient member has approved the for-study disclosure of, for the purpose of study, education or learning, but is not involved in medical practice.

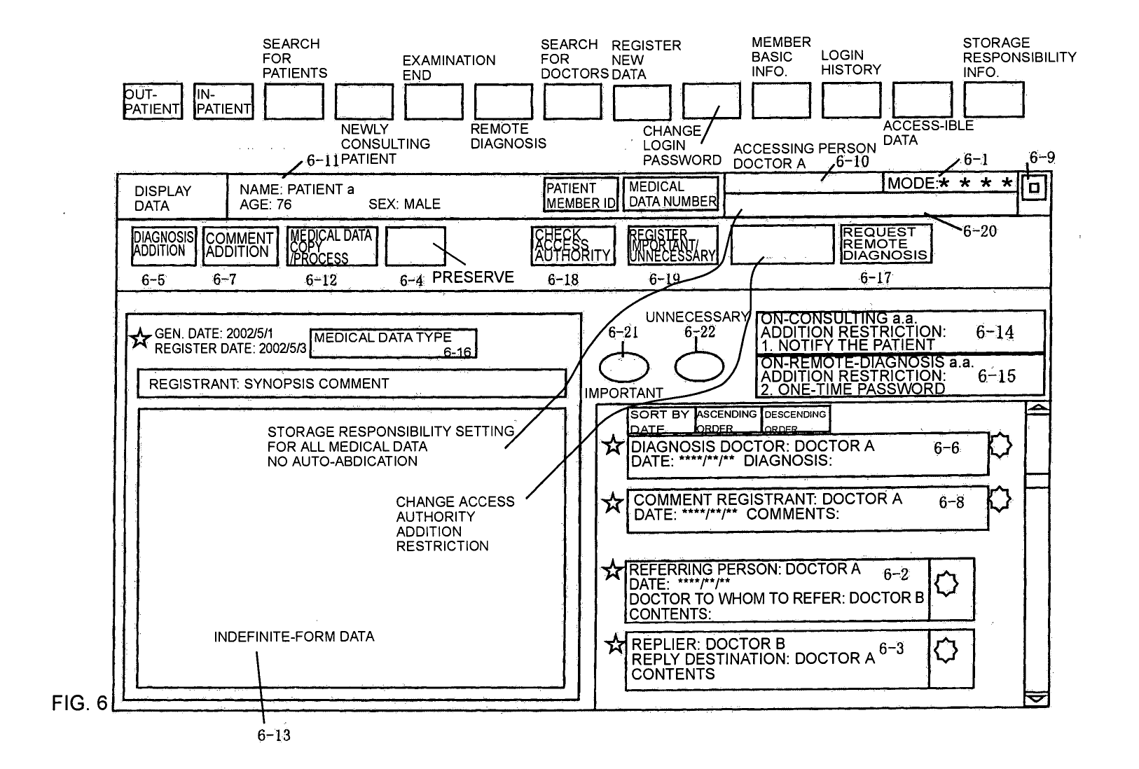

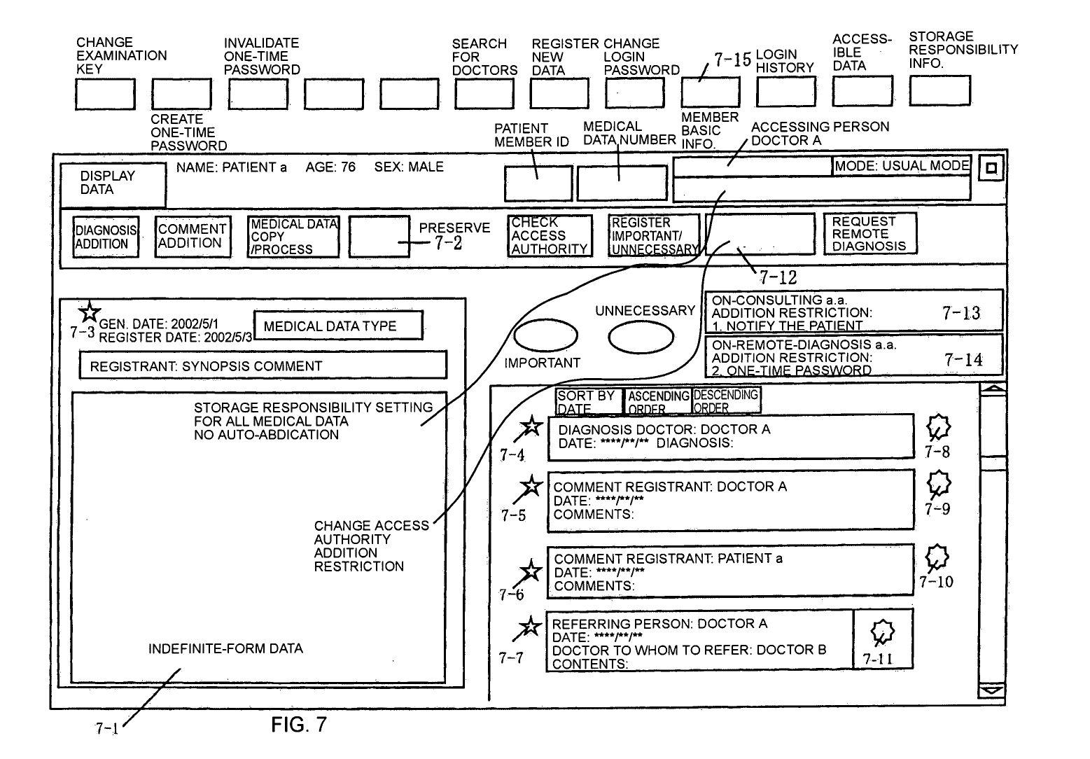

FIG. 14 shows paths from a global menu for each member to a medical data detail browse screen for registering, browsing, and processing medical data. After logging in (S14-1), each member reaches a medical data detail browse screen for the member's type through the path usable for the type (for example, FIG. 6 for doctors and FIG. 7 for patients). For example, the path from a newly consulting patient button of the global menu (S14-2) and the path from a remote diagnosis button (S14-3) are usable by only the doctor members; the path from an accessible data button (S14-5) and the path from a management responsibility information button (S14-6) are usable by all the members; and the path from a new data register button (S14-4) is usable by the doctor members, paramedic members, and patient members.

In the medical data management system of the present embodiment, when requesting remote diagnosis, a person requesting remote diagnosis has to be a member having authority of access to medical data to be used in remote diagnosis. By enabling a member having authority of access to medical data to give another doctor member authority of access to the medical data, the another doctor member to be requested for remote diagnosis can access the medical data, and thus, access authority for remote diagnosis is secured without relying on the access authority addition authentication means.

In the embodiment, a login password is used as an example of the login authentication means, and a password as an example of the access authority addition authentication means is called an examination key. Furthermore, disposable password is used as an example of disposable authentication means, and is called a one-time password.

Note that the disposable authentication means is means that can be used only once to release the protection in the case where a protection against addition of authority of access to medical data is set. The disposable authentication means includes common disposable authentication means usable for all protected data (a common one-time password, herein), and particular disposable authentication means to release only the protection of particular medical data (a particular one-time password, herein).

For example, if there are a plurality of medical data protected by one common one-time password, the protection of any one can be released with the one common one-time password. In contrast, for medical data protected by a particular one-time password, the protection cannot be released without the particular one-time password for the medical data.

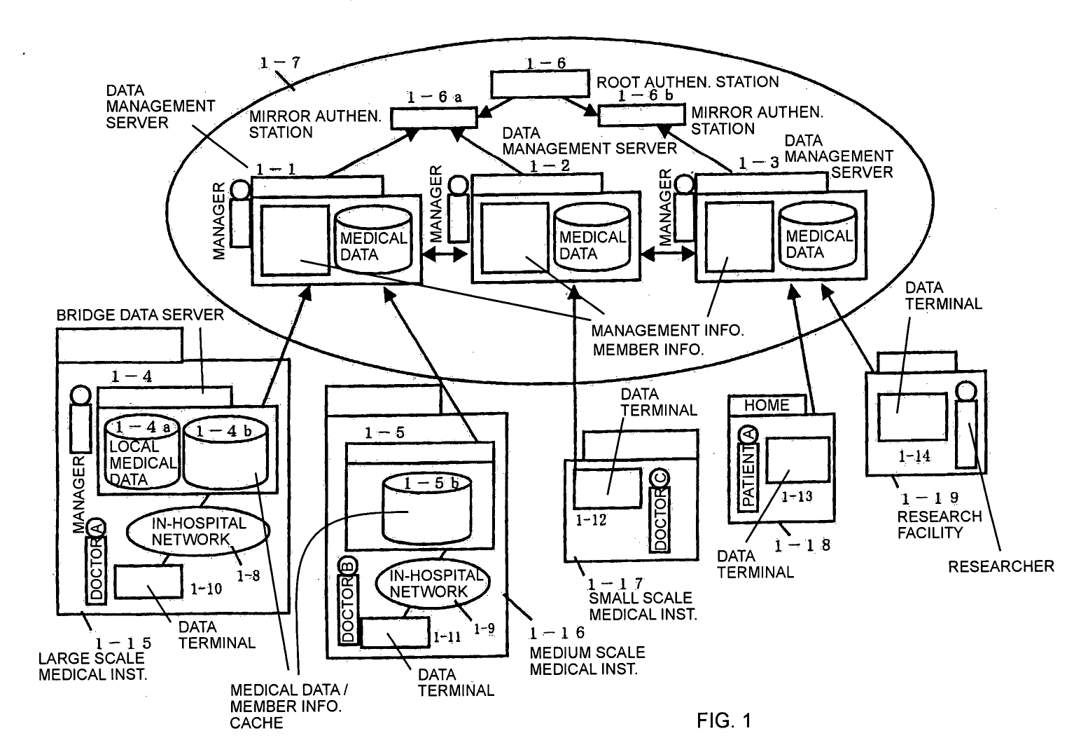

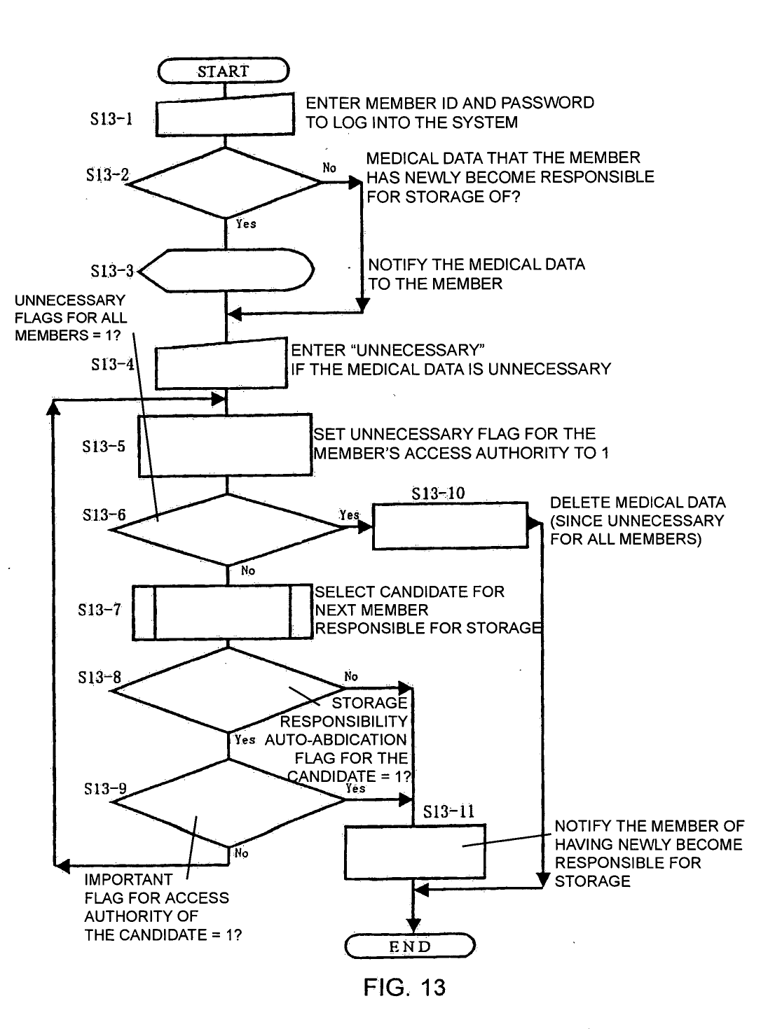

A description will be made below in detail with reference to FIGS. 1 to 14.

For example, as shown in FIG. -1, a network system set up on the Internet 1-7, an in-hospital network 1-8 set up in a large scale medical institution 1-15, an in-hospital network 1-9 set up in a medium scale medical institution 1-16, and a data taking-in reference terminal 1-12 installed in a small scale medical institution 1-17 are connected via communication lines so as to configure a network such as VPN, WAN, or dedicated lines as needed.

The network system set up on the Internet 1-7 comprises data management servers 1-1, 1-2, 1-3, mirror authentication stations 1-6a, 1-6b provided in an upper layer of the data management servers, and a root authentication station 1-6.

The data management servers 1-1, 1-2, 1-3 are in cooperation with each other using encrypted communication, and perform registering, storage, browsing, access authority management, and the like of medical data.

The authentication in encrypted communication between the data management servers 1-1, 1-2, 1-3 is performed by root authentication station 1-6 and mirror authentication stations 1-6a, 1-6b in a distributed manner.

The data management servers 1-1, 1-2, 1-3 hold files of medical data, member information, and management information (medical data management files, etc.), and store programs for managing medical data, and are managed by an administrator.

The network system set up in the large scale medical institution 1-15 comprises a bridge data server 1-4 and a data taking-in reference terminal 1-10, and is managed by an administrator or the like, and used by a doctor member A and the like.

The network system set up in the medium scale medical institution 1-16 comprises a bridge cache server 1-5 and a data taking-in reference terminal 1-11, and is used by a doctor member B and the like.

The small scale medical institution 1-17 comprises a data taking-in reference terminal 1-12, and is used by a doctor member C and the like.

The configurations set up in the large scale medical institution 1-15, the medium scale medical institution 1-16, and the small scale medical institution 1-17 will be described in detail.

Bridge data server 1-4 and bridge cache server 1-5 are respectively connected to data taking-in reference terminals 1-10, 1-11 via in-hospital networks 1-8, 1-9, and connected to the data management server 1-1 via the Internet 1-7.

Bridge data server 1-4 has functions to store medical data registered in the large scale medical institution 1-15 and to store temporarily medical data registered in a place other than the large scale medical institution 1-15 that has been requested by data taking-in reference terminal 1-10 of the large scale medical institution 1-15, and is expected to have a shorter processing time when the same data is requested again, and is improved in security.

That is, bridge data server 1-4 comprises a hard disk 1-4a on which the large scale medical institution 1-15 can store local medical data (medical data for itself) and a hard disk 1-4b having a function to cache medical data, member information, and management information.

Bridge cache server 1-5 has a function to store temporarily medical data that has been requested by data taking-in reference terminal 1-11 of the medium scale medical institution 1-16, and is expected to have a shorter processing time when the same data is requested again, and is improved in security. That is, bridge cache server 1-5 comprises a hard disk 1-5b having a function to cache medical data, member information, and management information.

In the small scale medical institution 1-17, a home 1-18, a research facility 1-19, data taking-in reference terminals 1-12, 1-13, 1-14 are respectively connected to data management servers 1-1, 1-2, 1-3 via the Internet 1-7. Note that the above servers and terminals are administered by an appropriate operating system such as Windows NT™, Windows XP™, or Linux™.

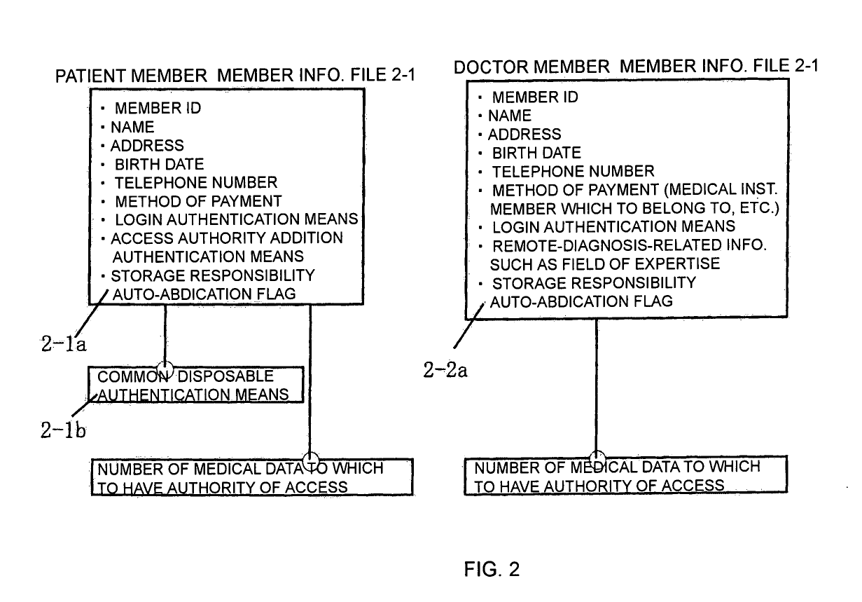

Member information stored on the hard disks of data management servers 1-1, 1-2, 1-3 includes member information registered when the members are registered. FIG. 2 shows an example of member information files 2-1, 2-2 of a patient member and a doctor member. Note that instead of the above hard disks, storage apparatuses such as semiconductor disks may be used.

Member information file 2-1 of a patient member contains all or some of individual identification information such as member ID, patient name, address, birth date, and telephone number, and a method of the payment of fees, login authentication means (for example, a login password), access authority addition authentication means (for example, an examination key), a storage responsibility auto-abdication flag 2-1a, the number of medical data to which the patient member has authority of access, and common disposable authentication means 2-1b (one of the disposable authentication means that is a common one-time password), according to need.

Member information file 2-2 of the doctor member contains individual identification information such as member ID, doctor name, address, birth date, and telephone number, and a method of the payment of fees, information about the medical institution member that the doctor member belongs to, login authentication means (for example, a login password), remote-diagnosis-related information such as the field of expertise, a storage responsibility auto-abdication flag 2-2a, and the number of medical data to which the doctor member has authority of access.

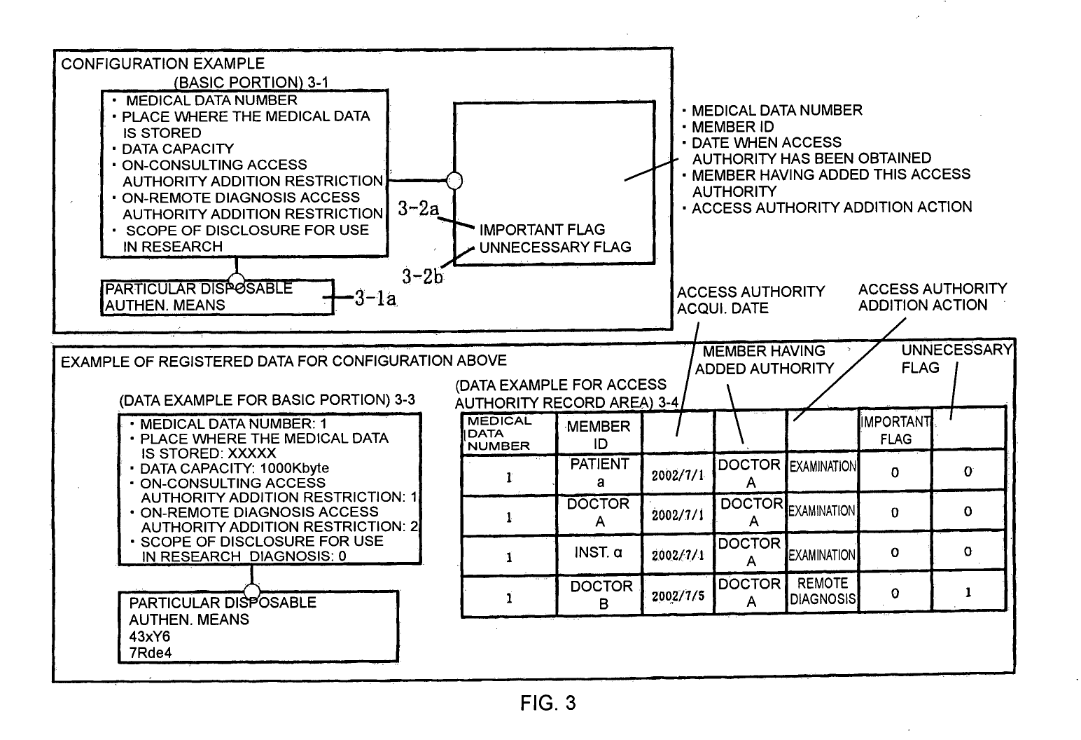

FIG. 3 shows a configuration example of the medical data management file. The medical data management file 3 has a basic portion 3-1 and an access authority record area 3-2, and the basic portion 3-1 contains a medical data number, the place where the medical data is stored, its data capacity, an on-consulting access authority addition restriction, an on-remote-diagnosis access authority addition restriction, particular disposable authentication means 3-1a (one of the disposable authentication means that is a particular one-time password), and a scope of disclosure for use in research. The access authority record area 3-2 contains, for each member having access authority, information such as a medical data number, member ID, the date when access authority has been obtained, the member ID of the member having added this access authority, access authority addition action (indicating the action that led to access authority addition such as medical examination or remote diagnosis), an important flag 3-2a, and an unnecessary flag 3-2b. Also, FIG. 3 shows a data example 3-3 for the configuration example of the basic portion 3-1 of the medical data management file 3 and a data example 3-4 for the configuration example of the access authority record area 3-2.

Next, the medical data management system of the present embodiment will be described with reference to FIGS. 1, 3, 4, 5, 6, 7, and 8.

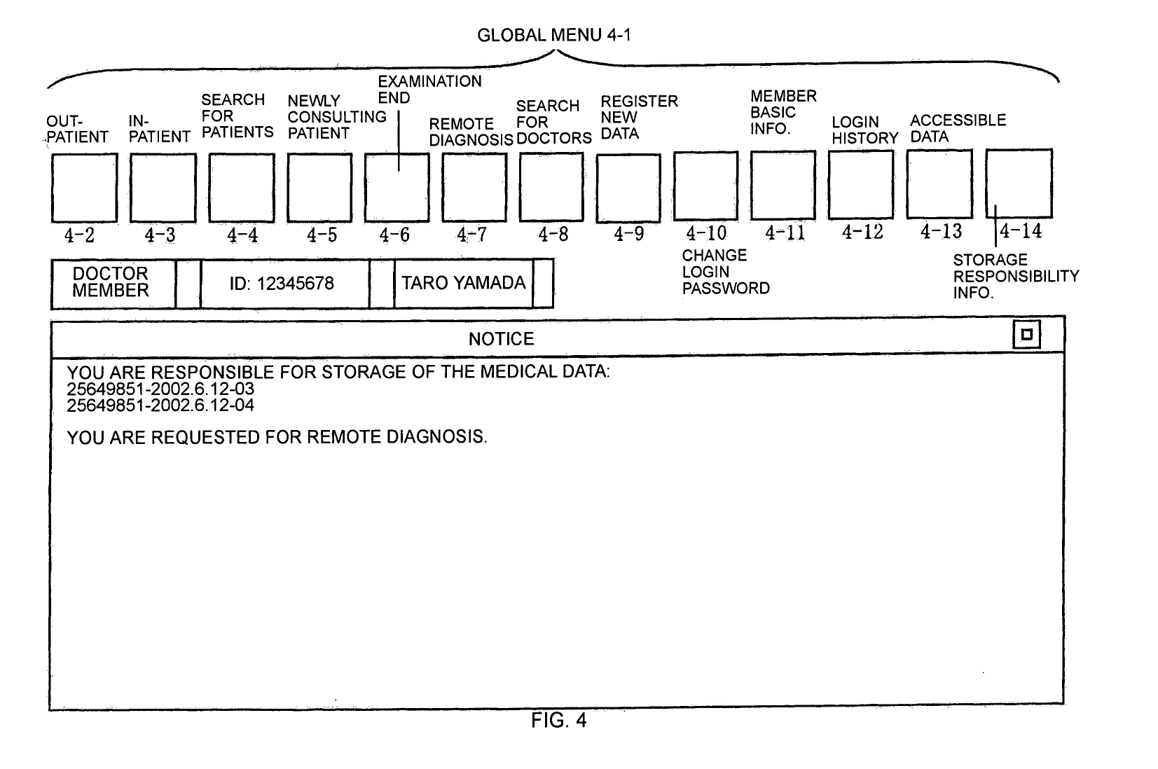

A member accesses a home page screen (not shown) of the medical data management system through data taking-in reference terminal 1-10, 1-11, 1-12, 1-13, or 1-14 of FIG. 1 and inputs his member ID and login authentication means (for example, a password) to log into the system. Thereafter, an after-logging-in initial screen 4 of FIG. 4 is displayed.

A global menu 4-1 displayed at the top of the after-logging-in initial screen 4 is a menu of buttons having functions different according to the member type and is always, generally displayed, and only ones of the functional buttons executable on each screen become valid. The member can switch from this global menu to a desired process screen. These menu buttons may be assigned to functional keys arranged on an input device such as a keyboard. Furthermore, the display screens of this management system illustrated in the above-mentioned and later-mentioned figures show a design example thereof, and hence, also other screen designs that those skilled in the art can easily come up with based on their knowledge are within the scope of the present invention.

For example, the global menu 4-1 for doctor members has an outpatient button 4-2 for displaying the list of outpatients, an inpatient button 4-3 for displaying the list of inpatients, a patient search-for button 4-4 for searching for patients, a newly consulting patient button 4-5 for designating a newly consulting patient, an examination end button 4-6 for ending an examination mode, a remote diagnosis button 4-7 for executing remote diagnosis, a doctor search-for button 4-8 for searching for doctors, a new data register button 4-9 for newly registering medical data, a login password change button 4-10 for changing login authentication means, a member basic information button 4-11 for displaying addresses and the like of members, a login history button 4-12 for checking the login histories of members, an accessible data button 4-13 for displaying a list of the medical data to which the doctor member has authority of access, and a storage responsibility information button 4-14 for displaying a list of the medical data for which the doctor member has storage responsibility.

In addition to the global menus, there are local menus to be displayed on only screens that a switch has been made to, and their functional buttons are displayed as needed.

Next, the flow for the case where a new outpatient takes medical examination in the large scale medical institution 1-15 of FIG. 1 will be described. First, the medical institution member accepts the patient using an outpatient accepting button (not shown).

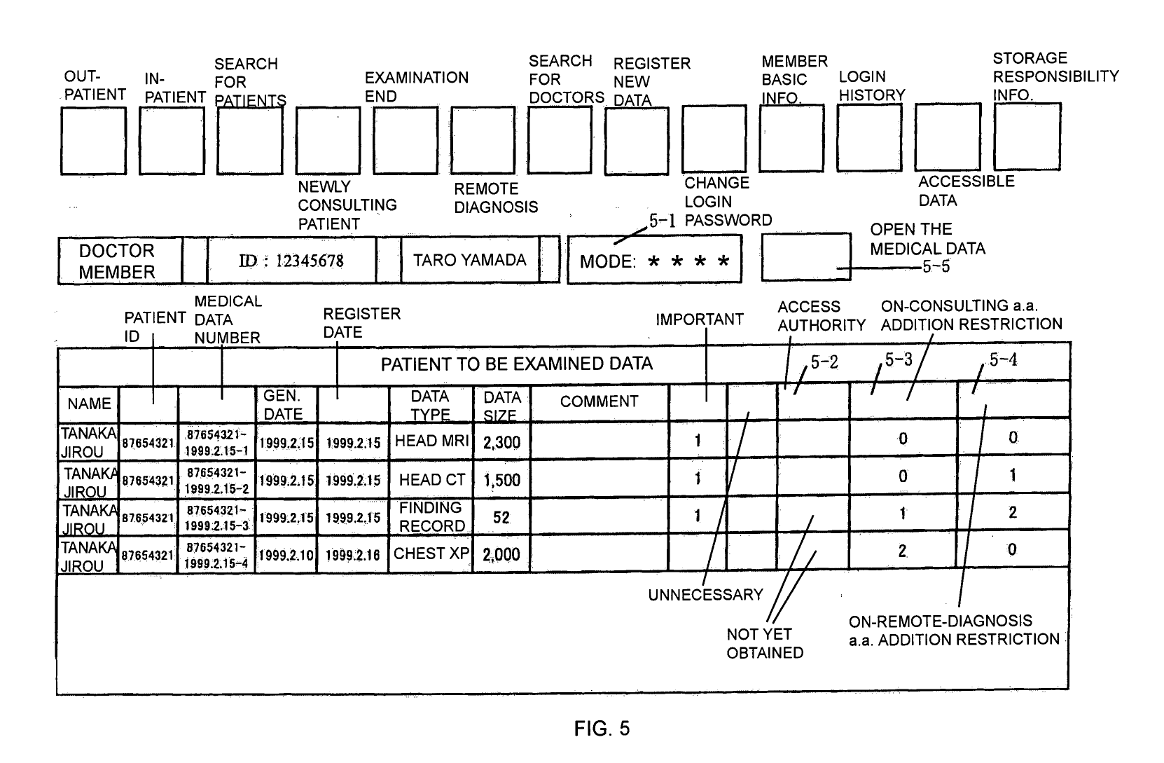

When a doctor member clicks on outpatient button 4-2 of the global menu 4-1 of FIG. 4, a list of outpatients (not shown) is displayed. Then, the doctor member identifies the outpatient, and clicks on the newly consulting patient button 4-5. Then, an examination key is requested, and if the examination key is true, a patient-to-be-examined data list screen 5 of FIG. 5 is displayed, and hereafter, “examination mode” is displayed in an access mode box 5-1.

The patient-to-be-examined data list screen 5 of FIG. 5 displays both medical data to which the doctor member has authority of access (medical data in whose management file the access authority of the doctor member is recorded) and medical data to which the doctor member has not yet obtained authority of access (medical data in whose management file the access authority of the doctor member is not recorded).

For medical data to which the doctor member does not have authority of access, “not yet obtained” is displayed in an access authority column 5-2 of the patient-to-be-examined data list screen 5. If the patient member has set a “warning” as protection against access authority addition, in an on-consulting access authority addition restriction column 5-3 or an on-remote-diagnosis access authority addition restriction column 5-4, the access authority addition restriction being at “1” is displayed, or if “protection by an one-time password” is set, the access authority addition restriction being at “2” is displayed.

When the doctor member selects medical data from the patient-to-be-examined data list screen 5 and clicks on an “open the medical data” button 5-5, a medical data detail browse screen (for doctors) 6 of FIG. 6 opens. Thereafter, the medical data management system recognizes as the “examination mode” the process up to selecting the examination end button 4-6 of the for-doctor-member global menu 4-1 of FIG. 4. This mode is displayed in an access mode box 6-1. The “examination mode” refers to the state where authority of access to medical data of a patient member can be added and registered by a doctor member and the like.

Next, the register of new medical data will be described.

For example, when the doctor member clicks on the new data register button 4-9 of the for-doctor-member global menu 4-1 of FIG. 4, the medical data management system requests a patient member ID and an examination key for medical data to be registered. When these are input, the examination mode is set up and a new medical data number is generated for the patient member.

The medical data management system, in the examination mode, displays a new medical data detail browse screen (for doctors) 6 having the generated medical data number, the current member information of the patient member, and an indefinite-form data box 6-13 that is blank as shown in FIG. 6. The doctor member inputs indefinite-form data and clicks on a preserve button 6-4. Then, the medical data is preserved in the system.

Until the preserve button 6-4 is clicked on, alteration is possible. If clicking on a close box 6-9 to close the medical data detail browse screen (for doctors) 6 without clicking on the preserve button 6-4, the generated medical data number and information associated therewith are all discarded.

If trying to close the medical data detail browse screen (for doctors) 6 without clicking on the preserve button 6-4, a warning is issued.

Members having authority of access to new medical data are initially doctor A displayed in an accessing person column 6-10 and patient a displayed in a display data column 6-11.

Note that in case a member other than the patient member registers new medical data as above, a function to register, by the patient member, the initial values for on-consulting access authority addition restriction and on-remote-diagnosis access authority addition restriction of medical data beforehand and to set automatically in the new medical data may be provided. By this function, even when a member other than the patient member has registered new medical data, immediately after the register of the new medical data, protecting the privacy of the patient member is enabled.

Where the doctor member finishes examination of a patient member and starts to examine a next patient member, the doctor member finishes examination by clicking on the examination end button 4-6 of FIG. 4, and selects a next patient member, clicks on the newly consulting patient button 4-5, and enters the examination key of the next patient member.

Where a patient member registers medical data, after logging in, clicking on a new data register button of a global menu for patient (not shown) generates a new medical data number.

The medical data management system records the generated medical data number and the current member information of the patient member, and displays a medical data detail browse screen (for patients) 7 having an indefinite-form data portion 7-1 that is blank as shown in FIG. 7. The patient member inputs indefinite-form data and finally clicks on a preserve button 7-2 to preserve in the system.

Until the preserve button 7-2 is clicked on, alteration is possible. If closing the medical data detail browse screen (for patients) 7 without clicking on the preserve button, the generated medical data number and information associated therewith are all discarded.

If trying to close the medical data detail browse screen (for patients) 7 without clicking on the preserve button 7-2, a warning is issued.

Members having authority of access to medical data created by the patient member are initially only the patient member.

The medical data detail browse screen (for doctors) 6 of FIG. 6 is provided with, as a local menu, a diagnosis addition button 6-5, a comment addition button 6-7, a medical data copy/process button 6-12, a preserve button 6-4, an access authority check button 6-18, an important/unnecessary register button 6-19, and a remote diagnosis request button 6-17. The medical data detail browse screen (for patients) 7 of FIG. 7 is provided with an access authority addition restriction change button 7-12 as a local menu. Note that only the patient member can use the access authority addition restriction change button 7-12.

The diagnosis addition button 6-5 of FIG. 6 is usable by only a doctor member, and when clicked on, a diagnosis box 6-6 is displayed additionally. When a diagnosis result is entered and the preserve button 6-4 is clicked on, the diagnosis result is registered together with the name of the doctor who diagnosed in the medical data management system.

Until the preserve button 6-4 is clicked on, alteration is possible. If closing the medical data detail browse screen (for doctors) 6 without clicking on the preserve button, the diagnosis result is discarded.

The comment addition button 6-7 is usable by the doctor members, paramedic members, and patient members, and when clicked on, a comment box 6-8 is displayed additionally. When a comment is entered and the preserve button 6-4 is clicked on, the comment is registered together with the name of the person who has registered the comment in the medical data management system.

Until the preserve button 6-4 is clicked on, alteration is possible. If closing the medical data detail browse screen (for doctors) 6 without clicking on the preserve button, the entered comment is discarded.

The medical data copy/process button 6-12 is usable by the doctor members, paramedic members, patient members, and researcher members and when clicked on, a new medical data detail browse screen having only the indefinite-form data copied therein without information of diagnosis box 6-6 and comment box 6-8, and a new medical data number are created.

Note that the settings of access authority addition restriction of an on-consulting access authority addition restriction box 6-14 and an on-remote-diagnosis access authority addition restriction box 6-15 are taken over from the original medical data.

When the member edits the copied new data, enters comments and the like, and clicks on the preserve button 6-4, the edited information is preserved in the medical data management system.

Thus, the original medical data and the edited, copied medical data both remain in the medical data management system.

Here, the initial data of a medical data type column 6-16 for the edited, copied medical data is a “copy of medical data”, and members having authority of access to this data are initially the creator and the patient member of the original medical data.

The access authority check button 6-18 is a button for checking members having authority of access to this medical data, and when clicked on, a list of persons having access authority (not shown) is displayed, and the member can check the persons having access authority.

With the important/unnecessary register button 6-19 of FIG. 6, the important flag 3-2a and unnecessary flag 3-2b of FIG. 3 can be set, and near, for example, the center of the medical data detail browse screen (for doctors) 6, an important flag mark 6-21 and an unnecessary flag mark 6-22 are displayed.

The important flag mark 6-21 indicates that, for the marked data, storage responsibility is not to be abdicated automatically even when the member has set auto-abdication of storage responsibility for all data (shown in a storage condition setting box 6-20). In contrast, the unnecessary flag mark 6-22 indicates that the member has declared the medical data unnecessary. Note that, if both the unnecessary flag and important flag are set, the unnecessary flag has priority over the other.

The access authority addition restriction change button 7-12 of FIG. 7 is a functional button usable by only the patient member, and is for setting access authority addition restriction, for when adding authority of access to the medical data, to no protection, setting of a warning, or setting of a one-time password.

The access authority addition restrictions are displayed in an on-consulting access authority addition restriction box 7-13 and an on-remote-diagnosis access authority addition restriction box 7-14 of FIG. 7.

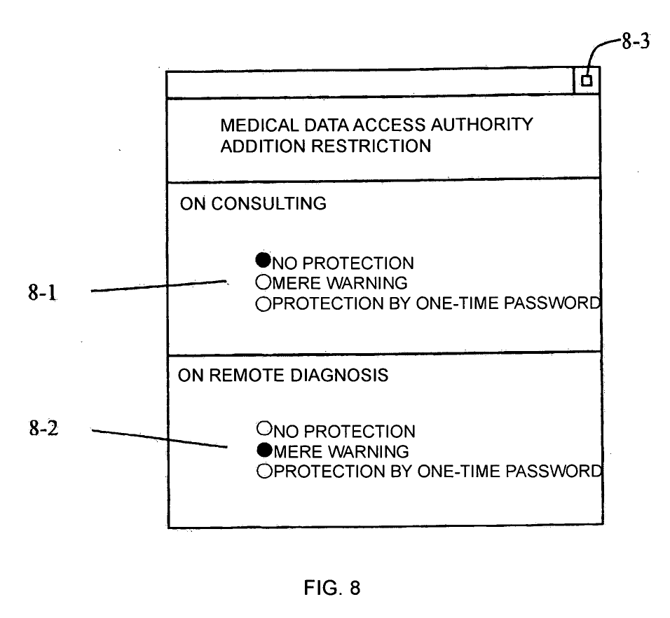

When clicking on the access authority addition restriction change button 7-12 of FIG. 7, a medical data access authority addition restriction setting window 8 opens as shown in FIG. 8, and a choice for the access authority addition restriction can be made from radio buttons 8-1 and 8-2. The setting window 8 is closed using a close button 8-3 on the upper right corner.

The remote diagnosis request button 6-17 is a button for requesting remote diagnosis. The remote diagnosis will be described with reference to FIGS. 3, 4, and 6.

In remote diagnosis, registering information about remote diagnosis, extracting a doctor to whom to refer the patient (doctor to be requested for remote diagnosis), and requesting remote diagnosis, and making a reply to the remote diagnosis, and evaluating the remote diagnosis are performed by doctor members.

A doctor member registers a specialty for remote diagnosis, field of expertise, conditions for remote diagnosis, and the like beforehand by using the member basic information button 4-11 of the global menu of FIG. 4.

In searching for doctors to be requested for remote diagnosis, a member about to request remote diagnosis clicks on the doctor search-for button (e.g., doctor search-for button 4-8) described for the global menus for the types of members (e.g., for-doctor-member global menu 4-1 of FIG. 4) to search for doctors to be requested for remote diagnosis. When searched for with conditions such as a name, a specialty, and a field of expertise inputted, a screen with a list of doctors to be requested for remote diagnosis (not shown) is obtained as a result of searching information about remote diagnosis. For example, if a doctor member requests remote diagnosis, the doctor member opens the medical data detail browse screen (for doctors) 6 for medical data of a patient on whom remote diagnosis is to be requested. Then, the remote diagnosis request button 6-17 of the local menu is clicked on to display a screen for searching for doctors to be requested for remote diagnosis (not shown).

As a result of searching, the screen with a list of doctors to be requested for remote diagnosis (not shown) is displayed. Then, a doctor whom he wants to request to diagnose remotely is selected from the list.

After selecting a doctor to be requested, the process returns to the medical data detail browse screen 6 of FIG. 6. Here, a refer box 6-2 in which a doctor to refer the patient (doctor to request) and a doctor to whom to refer the patient (doctor to be requested) are automatically entered and a reply box 6-3 are created, and the doctor to request writes the contents of referring in the refer box 6-2.

When clicking on the preserve button 6-4, the contents of the refer box 6-2 is preserved in the medical data management system. In the access authority record area 3-2 of the management file of the medical data shown in FIG. 3, the member ID of the doctor to be requested is recorded additionally. At the same time, the request for remote diagnosis is sent to the destination.

Until the preserve button 6-4 is clicked on, alteration is possible. If trying to close the medical data detail browse screen (for doctors) 6 without clicking on the preserve button 6-4, a warning is displayed (not shown). If closing the medical data detail browse screen (for doctors) 6 ignoring the warning, the created reference is discarded.

The doctor to be requested for remote diagnosis can confirm that there is a request for remote diagnosis, through a notice box 4-15 of the after-login initial screen of FIG. 4.

The doctor requested clicks on the remote diagnosis button 4-7 of the for-doctor-member global menu 4-1 of FIG. 4, and selects medical data to make a reply about from a list of requests for remote diagnosis (not shown). Here, the medical data detail browse screen (for doctors) 6 in a usual mode is displayed because the requested doctor's authority of access to the medical data has been added by the requester.

In the medical data detail browse screen (for doctors) 6, the refer box 6-2 and reply box 6-3 have been created by the remote diagnosis requester. The requested doctor writes remarks based on remote diagnosis in the reply box 6-3 and clicks on the preserve button 6-4 to preserve.

Until the preserve button 6-4 is clicked on, alteration is possible. If closing the medical data detail browse screen (for doctors) 6 without clicking on the preserve button 6-4, the written comments are discarded.

If trying to close the medical data detail browse screen (for doctors) 6 without preserving, a warning is displayed (not shown). If preserved, the requester is notified of the completion of the input into a remote diagnosis reply.

Next, the protection of medical data will be described with reference to FIGS. 1, 3, 5, 6, 7, 9, 10 and 11.

First, in order to restrict the addition of authority of access to medical data, a patient member sets access authority addition restriction to no protection, a warning, or protection with a one-time password by using the access authority addition restriction change button 7-12 in the local menu of the medical data detail browse screen (for patients) 7 of FIG. 7.

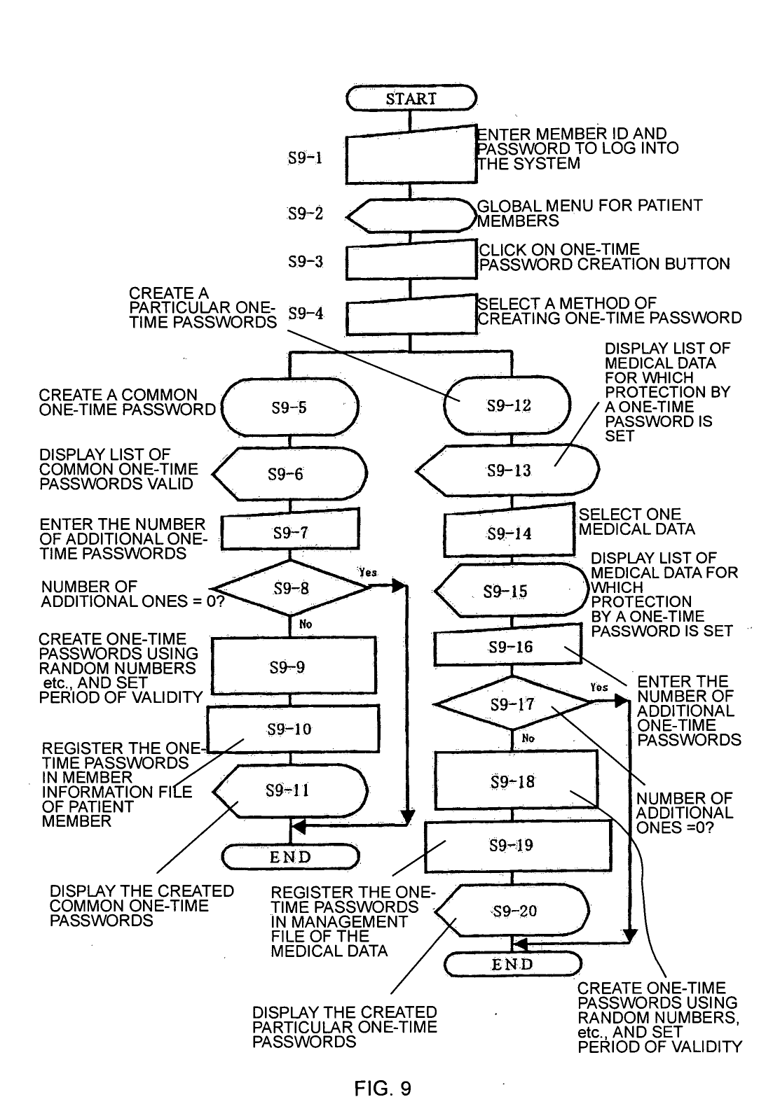

The patient member can create a one-time password (disposable authentication means) according to the flow of FIG. 9. First, the patient member enters his member ID and password to log into the medical data management system (S9-1), and has the global menu for patient members displayed (S9-2), and selects a one-time password creation button (S9-3).

There are two methods of creating a one-time password to select from (S9-4). If the one-time password to be created is a common one-time password common to all data protected (S9-5), a list of common one-time passwords currently valid is displayed (S9-6). If additional ones need to be created, the number of additional ones is entered (S9-7, S9-8). Then, the system creates common one-time passwords and sets a period of validity (S9-9) and registers the common one-time passwords in the member basic information file of the patient member (S9-10). Thereafter, the created common one-time passwords are displayed on screen (S9-11).

On the other hand, if the one-time password to be created is a particular one-time password to protect particular medical data (S9-12), a list of the medical data for which protection by a one-time password is set is displayed (S9-13), and one medical data is selected (S9-14). Then, particular one-time passwords currently valid are displayed (S9-15), and if additional ones need to be created, the number of additional ones is entered (S9-16, S9-17). Then, the system creates particular one-time passwords (S9-18) and registers them in the management file of the medical data (S9-19). Thereafter, a list of the created particular one-time passwords is displayed on screen (S9-20).

Where the above creation of one-time passwords is performed by data taking-in reference terminal 1-13 or the like of FIG. 1, the created one-time passwords can be printed. Where a cellular phone or another palm-top mobile communication device is connected to the Internet and one-time passwords are created via the device, the created one-time passwords are displayed on the monitor screen thereof.

These one-time passwords may be automatically created by the system using random numbers or the like, or the member himself may arbitrarily select a character string as a one-time password.

A patient member can set access authority addition restriction to one of the three levels: no protection, a warning, and protection by a one-time password. Thus, when the medical data detail browse screen is opened to examine a patient, or when remote diagnosis is performed, the access authority addition restriction is imposed.

In the on-consulting access authority addition restriction column 5-3, there is displayed the value of the on-consulting access authority addition restriction in the basic portion 3-1 of the medical data management file 3 of FIG. 3 (see data example 3-3 for the basic portion). In the on-remote-diagnosis access authority addition restriction column 5-4, there is displayed the value of the on-remote-diagnosis access authority addition restriction in the basic portion 3-1 of the medical data management file 3 of FIG. 3 (see data example 3-3 for the basic portion).

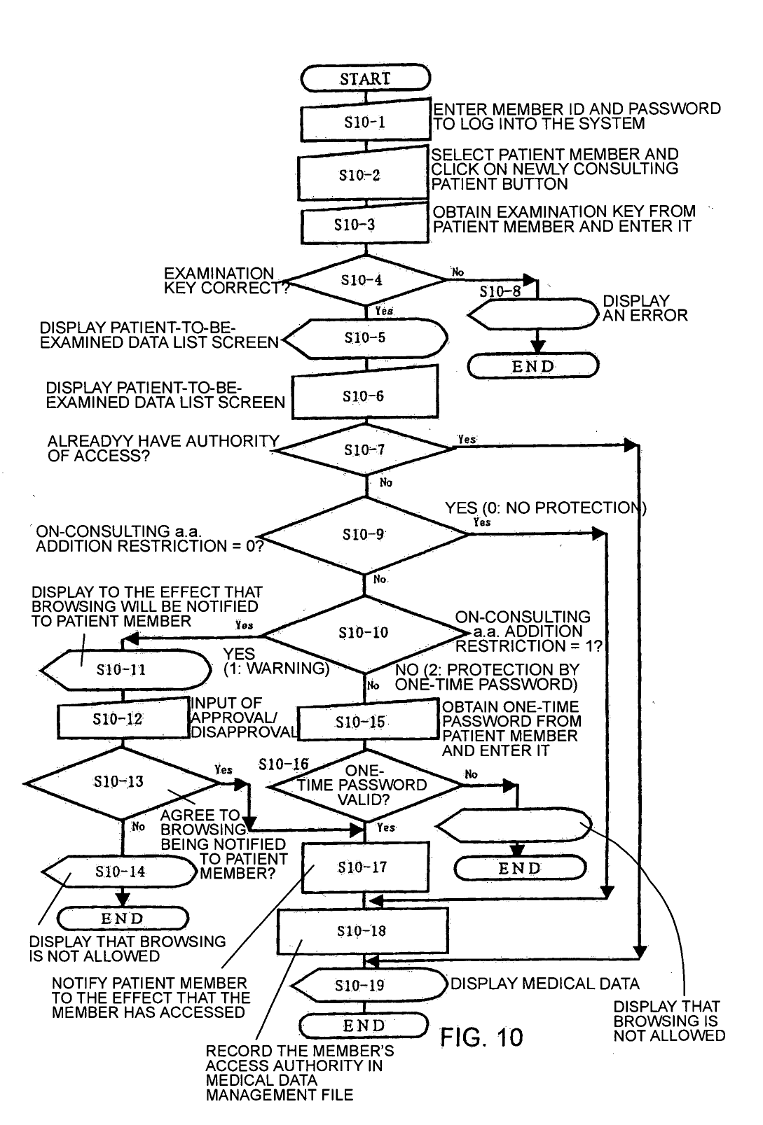

The on-consulting access authority addition restriction is executed according to the flow of FIG. 10. A doctor member enters his member ID and password to log into the medical data management system (S10-1), and selects a patient member and clicks on the newly consulting patient button (S10-2). Then, the medical data management system requires an examination key. The doctor member obtains an examination key from the patient member and enters it (S10-3). If the examination key is not correct (S10-4), an error is displayed and the process finishes (S10-8). If the examination key is correct (S10-4), the examination mode is set up and the patient-to-be-examined data list screen 5 is displayed (S10-5). When the doctor member selects medical data that he wants to access and clicks on the “open the medical data” button 5-5 (S10-6), if the doctor member already has authority of access to the medical data (S10-7), the medical data detail browse screen (for doctors) 6 of FIG. 6 is opened (S10-19).

If the selected medical data is one that the doctor member has not yet obtained authority of access to (S10-7), the following process is performed according to the on-consulting access authority addition restriction set by the patient member.

If “0” is displayed in the on-consulting access authority addition restriction column 5-3 of the patient-to-be-examined data list screen 5 shown in FIG. 5 (S10-9), it indicates that the patient member has not imposed any restriction on the on-consulting access authority addition. Hence, the doctor member's access authority is added to the management file of the medical data (S10-18), and the medical data is displayed in the medical data detail browse screen (for doctors) 6 (S10-19).

If “1” is displayed in the on-consulting access authority addition restriction column 5-3 of the patient-to-be-examined data list screen 5 shown in FIG. 5 (S10-10), it indicates that the patient member has set so as to issue a warning to the member accessing the medical data when adding authority of access to the medical data. A notice to the effect that the browsing will be notified to the patient member, such as “it will be notified to the patient member that you have opened the medical data and obtained access authority”, is displayed (S10-11). In the input of approval/disapproval in response to the warning (S10-12), if the doctor member does not agree to the warning (S10-13), it is displayed that browsing is not allowed (S10-14) and the process returns to the patient-to-be-examined data list screen 5 of FIG. 5.

On the other hand, in the input of approval/disapproval (S10-12), if the doctor member agrees to the warning (S10-13), the system notifies the patient member to the effect that the doctor member has accessed the medical data (S10-17) and additionally records the doctor member's access authority in the management file of the medical data (S10-18), and displays the medical data in the medical data detail browse screen (for doctors) 6 (S10-19).

In contrast, if “2” is displayed in the on-consulting access authority addition restriction column 5-3 of the patient-to-be-examined data list screen 5 shown in FIG. 5, because the on-consulting access authority addition restriction is not “0” or “1” (S10-9, S10-10), it indicates that the patient member has set protection by a one-time password on addition of access authority, and it is displayed “it needs a one-time password to open this medical data and obtain access authority”. Hence, the doctor member has to obtain a one-time password from the patient member and input it (S10-15). When the one-time password is valid (S10-16), the system notifies the patient member to the effect that the doctor member has accessed the medical data (S10-17) and additionally records the doctor member's access authority in the management file of the medical data (S10-18), and displays the medical data in the medical data detail browse screen (for doctors) 6 (S10-19).

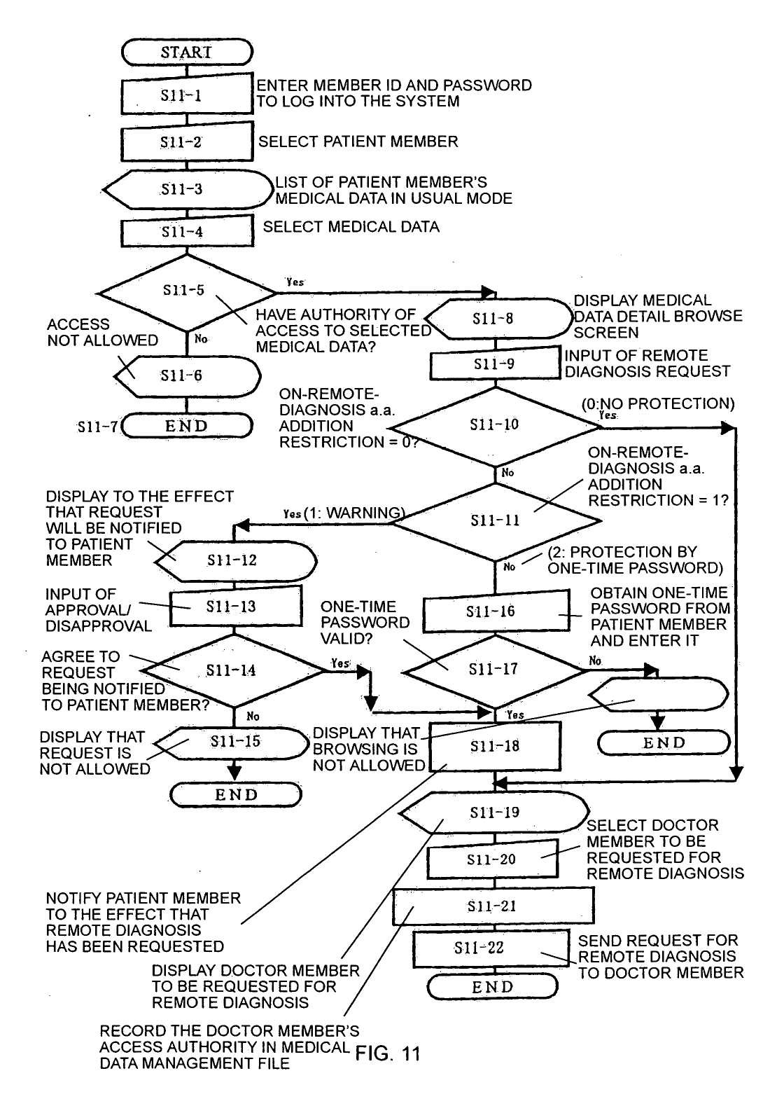

Next, the on-remote-diagnosis access authority addition restriction will be described based on the flow chart of FIG. 11. A doctor member enters his member ID and password to log into the medical data management system (S11-1), and selects a patient member (S11-2). Then, the patient-to-be-examined data list screen 5 of FIG. 5 is displayed in a usual mode. At this time, “usual” is displayed in the access mode box 5-1 (S11-3). When the doctor member selects medical data that he wants to access from the patient-to-be-examined data list screen 5 (S11-4) and clicks on the “open the medical data” button 5-5, if the doctor member does not have authority of access to the selected medical data (S11-5), the system displays that the access is not allowed (S11-6) and the process ends (S11-7). If the doctor member already has authority of access to the medical data (S11-5), the medical data detail browse screen (for doctors) 6 of FIG. 6 is opened (S11-8).

After the medical data detail browse screen (for doctors) 6 of FIG. 6 is opened (S11-8), in the case of referring the patient for remote diagnosis, the remote diagnosis request button 6-17 of the local menu is clicked on (S11-9). Then, depending on the value displayed in the on-remote-diagnosis access authority addition restriction column 5-4 of the patient-to-be-examined data list screen 5 of FIG. 5, the value having been set by the patient member on the medical data, the process forks as follows.

If the patient member has set “0” in the on-remote-diagnosis access authority addition restriction column indicating that no restriction is imposed (S11-10), a list of doctor members to accept a request for remote diagnosis is displayed (S11-19). When a doctor member to be requested for remote diagnosis is selected (S11-20), the access authority of the to-be-requested doctor member is added to the medical data management file (S11-21). Thereafter, the request for remote diagnosis is sent to the to-be-requested doctor member (S11-22).

If the patient member has set “1” in the on-remote-diagnosis access authority addition restriction column 5-4 of the patient-to-be-examined data list screen 5 of FIG. 5 indicating that a warning will be issued (S11-11), the system displays a warning to the effect that a request having been made is notified to the patient member, for example, “a remote diagnosis request for the medical data being made will be notified to the patient member” (S11-12). In the input of approval/disapproval (S11-13), if the doctor member does not agree to the remote diagnosis request being notified to the patient member (S11-14), it is displayed that a remote diagnosis request is not allowed (S11-15) and the process returns to the medical data detail browse screen (for doctors) 6 of FIG. 6.

If the doctor member agrees to the remote diagnosis request being notified to the patient member (S11-14), the patient member is notified to the effect that the doctor member has requested remote diagnosis (S11-18), and a list of doctor members to accept a request for remote diagnosis is displayed (S11-19). When a doctor member to be requested for remote diagnosis is selected (S11-20), the access authority of the to-be-requested doctor member is added to the medical data management file (S11-21). Then, the request for remote diagnosis is sent to the to-be-requested doctor member (S11-22) and the process finishes.

If the patient member has set “2” in the on-remote-diagnosis access authority addition restriction column 5-4 of the patient-to-be-examined data list screen 5 of FIG. 5 indicating that protection by a one-time password is set (S11-10, S11-11), the system displays “it needs a one-time password to request remote diagnosis for this medical data”. Then, the doctor member obtains a one-time password from the patient member and input it (S11-16). Only when the one-time password is valid (S11-17), the system notifies the patient member to the effect that another member has requested remote diagnosis (S11-18), and when a doctor member to be requested for remote diagnosis is selected (S11-19, S11-20), additionally records the doctor member's access authority in the management file of the medical data (S11-21). Then, the request for remote diagnosis is sent to the to-be-requested doctor member (S11-22) and the process finishes.

In this way, also in the case where the medical data management system of the present embodiment is applied to a wide area network, the patient members can control the addition of access authority, thus achieving remote diagnosis securely.

Next, the research use of medical data in the present system will be described with reference to FIG. 7.

If a patient member has a will to disclose his medical data for the research use, the patient member marks a check on a medical data research disclosure check box (not shown) of a member information setting screen (not shown) opened via a member basic information button 7-15 shown in FIG. 7.

If there is not a check on the medical data research disclosure check box, all medical data of the patient member are not disclosed. If there is a check, for each of his birth date, address, and sex, it can be individually specified whether to be disclosed.

Furthermore, when a research disclosure check box 7-3 for indefinite-form data that can be disclosed is marked with a check in the medical data detail browse screen (for patients) 7 of FIG. 7, the indefinite-form data including the medical data type and synopsis comment is allowed to be disclosed. By marking with a check a for-the-diagnosis-box research disclosure check box (for patients) 7-4, a for-the-comment-box research disclosure check boxes (for patients) 7-5, 7-6, and a for-the-refer-box research disclosure check box (for patients) 7-7, it can be individually specified whether to be disclosed. Note that only the patient member can switch the marking/unmarking of the research disclosure check boxes (for patients).

In the research disclosure of medical data, the members who have registered diagnosis, comments, a reference and a reply can register a will to disclose data created by themselves for research or permission to disclose, by marking with a check a for-the-diagnosis-box research disclosure check box (for registrants) 7-8, for-the-comment-box research disclosure check boxes (for registrants) 7-9, 7-10, and/or a for-the-refer-box research disclosure check box (for registrants) 7-11. Only ones of the diagnosis box, comment-box, and refer-box that both the patient member and the registrant have expressed a will to disclose are disclosed.

As a result of the registering of medical data for research, it becomes possible for researcher members to use the medical data.

A researcher member can search for medical data through a medical data search-for button (not shown) of the for-researcher-member global menu. When one is selected from medical data extracted, the screen changes to the detail browse screen (not shown) for the one medical data, and the researcher member's authority of access to the medical data is added.

Next, an embodiment of a method of determining a member responsible for storage so as to enable the selection and preserving of important medical data during a time period intended by members including the patient will be described with reference to FIGS. 2, 3, 12, 13.

A member responsible for storage is determined by confirming the wills of the members having authority of access to the medical data, and priority of members to become responsible for storage is determined according to the degree to which they need the medical data. When all members having authority of access have abdicated the storage responsibility, the medical data is discarded.

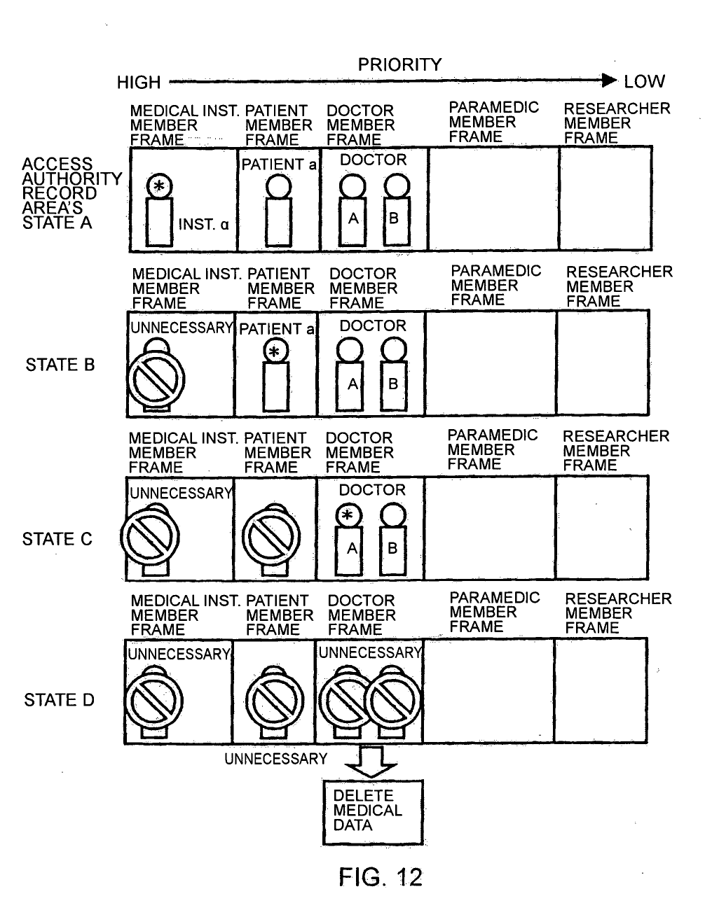

FIG. 12 is a diagram showing the data example 3-4 of the access authority record area of the medical data management file 3 shown in FIG. 3. For the case where members having authority of access to medical data are, for example, an institution ax as a medical institution member, a patient a as a patient member, and doctors A, B as doctor members, transitions of the state of the access authority record area are shown. An asterisk refers to a member responsible for storage of the medical data.

In the method of determining a member responsible for storage, with the descending priority order of medical institution members, patient members, doctor members, paramedic members, and researcher members, and assuming that a member who has obtained access authority earlier among the same type of members has higher priority, a member responsible for storage that has highest priority is institution a. At this time, the access authority record area of the medical data management file is indicated by state A of FIG. 12. Note that the method of determining a member responsible for storage is not limited to this embodiment, but can be changed depending on the way to use the medical institutions.

Here, if institution a declares the medical data unnecessary, the storage responsibility is transferred to patient a having the next highest priority, and patient a is notified to the effect that the storage responsibility is transferred to patient a. Patient a receives the notice and if approving, becomes responsible for storage, which is indicated by state B of FIG. 12. On the other hand, if patient a declares the medical data unnecessary, the storage responsibility is transferred to a member having the next highest priority. Of the doctor members that are candidates for the next member responsible for storage, doctor A has obtained access authority earlier than doctor B. Hence, doctor A is determined to be the next member responsible for storage, and is notified to the effect that the storage responsibility is transferred to doctor A. The access authority record area gets in state C. Thereafter, until there is no candidate for the next member responsible for storage, the same process is repeated, and when no member is responsible for storage as indicated by state D, the medical data is deleted.

The members having access authority in the management file of the medical data can access the medical data until deleted even if having declared it unnecessary.

As above, a scheme is realized which confirms the wills of all the members having authority of access to the medical data and automatically deletes the medical data if all have declared it unnecessary. Note that for members having authority of access to many medical data, in case management of responsibility for storing the many medical data becomes cumbersome, storage responsibility auto-abdication flags 2-1a, 2-2a may be provided in member information files 2-1, 2-2 of FIG. 2.

Storage responsibility auto-abdication flag 2-1a or 2-2a being at 1 indicates declaring automatically the medical data unnecessary when the member becomes responsible for storage of medical data. Storage responsibility auto-abdication flag 2-1a or 2-2a being at 0 indicates accepting the notice each time the member becomes responsible for storage of medical data.

Moreover, as shown in FIG. 3, each member may set the important flag 3-2a in the access authority record area 3-2 of the management file of medical data that they consider important. If the important flag 3-2a is at 1 indicating that the medical data is especially important, auto-abdication-of-storage-responsibility is not performed even if the member has set storage responsibility auto-abdication flag 2-1a or 2-2a at 1.

The process of determining a member responsible for storage, and the important flag 3-2a and storage responsibility auto-abdication flags 2-1a, 2-2a will be described with reference to FIGS. 2, 3, 13.

A member enters his member ID and password to log into the medical data management system (S13-1). If there is medical data that the member has newly become responsible for storage of (S13-2), the medical data is notified to the member (S13-3). Here, when the medical data that the member has storage responsibility for is unnecessary, the member declares it unnecessary by entering “unnecessary” (S13-4). As a result, the unnecessary flag 3-2b for the member's access authority in the management file of the medical data becomes 1 (S13-5).

If the unnecessary flags 3-2b for all members having authority of access to the medical data are at 1 (S13-6), the medical data is deleted (S13-10) and the process finishes.

If a member of the members having authority of access to the medical data has set the unnecessary flag 3-2b at 0, a candidate for the next member responsible for storage is selected from the management file of the medical data (S13-7).

If storage responsibility auto-abdication flag 2-1a or 2-2a of member information file 2-1 or 2-2 of FIG. 2 is not at 1 for the candidate for the member newly responsible for storage (S13-8), the member is notified that the member has newly become responsible for storage (S13-11) and the process finishes.

If storage responsibility auto-abdication flag 2-1a or 2-2a of member information file 2-1 or 2-2 is at 1 for the candidate for the member newly responsible for storage (S13-8), the important flag 3-2a of FIG. 3 is marked with a check for the candidate for the member newly responsible for storage.

If the important flag 3-2a of the candidate for the member newly responsible for storage is at 1 (S13-9), the member is notified that the member has newly become responsible for storage (S13-11) and the process finishes.

If the important flag 3-2a of the candidate for the member newly responsible for storage is at 0 (S13-9), the process returns to S13-5 and continues with the same process.

As described above, the members are in charge of maintenance of the medical data, and the members sharing the medical data take charge of preserving it in order of their priority. Therefore, there is no risk that the medical data whose compulsory storage period has elapsed is lost.

Next, an embodiment of managing the medical data management system so as to contribute to the fields of medical economy will be described.

For example, the base of economy for managing the medical data management system is charges and advertisement fees, and charges on members include membership fees, system usage fees associated with the use of the system (remote diagnosis, the use of medical data by researcher members), storage fees of medical data, and the like.

In the case of performing remote diagnosis, a doctor member to receive a request for remote diagnosis can present his field of expertise and conditions for accepting the request for remote diagnosis, and the conditions may include conditions of fees. In this case, assuming that a charge occurs when a requesting member has requested remote diagnosis and the doctor member requested has created a reply, the system manager collects part of the charge as a system usage fee.

In the case of the research use of medical data, for example, when a medical researcher browses respective medical data of a plurality of patient members by using the system, the medical researcher is charged on a per medical data basis. At this time, the system manager collects a system usage fee. If patient members, the medical data supplier side, can require a fee for supplying medical data, it can be expected that the disclosure of medical data will be promoted.

When determining a storage fee for medical data, the medical data management system searches the management files of all medical data for the members responsible for storage, and tallies the amount of medical data recorded in the medical data management files and calculates the total amount of medical data of which each member is responsible for storage to charge a fee for it.

As to advertisement fees, the system administrator may post advertisements in, for example, a home page screen (not shown) or the after-logging-in initial screen 4 for each member of FIG. 4, and collect advertisement fees. Because it is an added value that advertisements on the system can be transmitted to a given type of members, an effective advertising effect can be expected. Furthermore, by injecting advertisement earnings into the system management expenditure, charges on members can be suppressed. Note that system usage fees associated with the use of the medical data management system and storage fees of medical data may be on a pay-as-you-go basis or on a flat rate basis or both.

In the medical data management system of the present embodiment, in order for patients to enjoy rights and convenience as much as possible, the patients to have their medical data registered and stored have to be members, but patients who are not members (hereinafter called non-member patients) can also use the medical data management system for convenience for medical professionals. In this case, in order to secure the security such as the prevention of unauthorized use of the medical data management system of the present embodiment, necessary restrictions are preferably imposed.

An example of the management of non-member patients will be described below, but does not limit the present invention.

For example, it is assumed that doctor members, paramedic members, and medical institution members can register non-member patients, and researcher members cannot.

When a non-member patient is registered, a patient ID and access authority addition authentication means are issued, but login authentication means is not issued to the non-member patient, and thus the non-member patient cannot log into the system.

The non-member patient's ID and access authority addition authentication means are managed by the doctor member, paramedic member, or medical institution member who registered the non-member patient.

Medical data is registered by a doctor member, paramedic member, or medical institution member using the non-member patient's ID and access authority addition authentication means, and only the member having registered the medical data has authority of access to the registered medical data and is responsible for storage of the medical data.

A request for remote diagnosis for medical data of the non-member patient can be implemented likewise by a member with access authority adding access authority of another member.

Since a non-member patient cannot login as a patient member, protection against other members adding authority of access to his medical data and disclosure for research is impossible.

Note that a non-member patient may be registered as a genuine patient member as needed, in which case the patient ID can continue to be used. It is preferable that login authentication means is newly registered and access authority addition authentication means is updated.

Where a non-member patient has become a patient member, the patient member may be allowed to obtain authority of access to the medical data registered in the past.

As described above, since the medical data management system of the present embodiment has, as members, patients, doctors, medical professionals except doctors, and medical institutions, and provides ID and login authentication means for each member, it can effectively use the Internet and utilize medical data.

Moreover, since a member can access individual medical data by recording the member's access authority in the management file associated with the medical data, it can be managed whether a member is allowed to access on a per individual medical data basis.

Furthermore, the access authority addition authentication means is provided for each patient member as means to enable recording newly a member's access authority in the management file. Hence, a method is provided that allows a doctor member to access the medical data of a patient member to which the doctor member has not yet obtained authority of access as well.

Yet further, since the access authority addition authentication means is provided as means to record a member's access authority in the management file and to enable recording newly a member's access authority in the management file, it is possible to access medical data after access authority is recorded in the management file thereof, without the access authority addition authentication means. Thus, the obtaining and holding of access authority are managed independently of each other.

A member whose access authority is recorded in the management file of medical data, by adding another member's access authority to the management file, enables the another member to access the medical data, and thus, a member having authority of access to medical data can give access authority to another member, thereby achieving the disclosure of the medical data between members of the system in remote diagnosis.

With the feature that patient members have their access authority automatically recorded in the management files of all their own medical data, the patient members can browse and disclose their own medical data. Thus, the right of the patients to know can be fully exercised.

Since patient members themselves can register their own medical data in the medical data management system, the patient members themselves can preserve information about their own physical state and the like, thus achieving the active management of medical information.

The medical data management system is configured to allow researcher members to participate and to allow patient members to disclose their own medical data on the system. Thus, information of medical sites can be used directly in study and education.

The system is configured to enable recording the scope of medical data that the patient member has approved in the management file of the medical data and disclosing medical data of the approved scope to researcher members. Hence, the disclosure/closure of the medical data is according to the patient member's will, and the medical data can be regarded as being subjected to informed-consent, and thus, is of high utility value.

Of the members whose access authority is recorded in a management file, a member to be responsible for storage of the medical data is determined in order of the degree to which they need the medical data. Hence, it is clear who is responsible for storage of medical data while a plurality of members have authority of access to the same medical data.

When the member responsible for storage abdicates the responsibility, the responsibility is transferred to the candidate for the next member responsible for storage. Hence, all members having access authority can become responsible for storage. Thus, necessary medical data is not discarded without the members recognizing it.

There is provided the function to delete the medical data when all members finally abdicate the storage responsibility. Thus, wasteful storage of data does not occur.

There is provided the function to enable searching for the member responsible for storage of each medical data and calculating the total amount of stored medical data for each member and charging for it. Hence, where a plurality of members have authority of access to the same medical data, a fee system taking the amount of stored data into account can be established, and a balance between the amount of stored data and usage fees is achieved.

Because the access authority addition authentication means of patient members can be changed, after the patient members tell another the access authority addition authentication means, they can invalidate the access authority addition authentication means by changing it to a new one, and thus the effect of protecting the medical data that is their own personal information can be expected.

In the present medical data management system, when another member adds authority of access to his own medical data designated by a patient member, a warning to the effect that the other member's action will be notified to the patient member is issued to the other member. Thus, the effect of preventing the unauthorized disclosure by the other member of the medical data that is personal information can be expected.

Moreover, by recording and notifying the other member's action to the patient member after the other member's action, the patient member can recognize the other member having given authority of access to his own medical data and a member to whom it is given.

The present medical data management system is configured to enable a patient member to register disposable authentication means which allows only once another member to add authority of access to medical data designated by the patient member and to require another member who tries to add access authority to input disposable authentication means when the disposable authentication means is set for the medical data. Therefore, the effect of strictly protecting the medical data can be expected.

Although the preferred embodiment of the present invention has been described in detail, the invention being not limited to the embodiment, it should be understood that various changes, substitutions and alterations can be made therein without departing from spirit and scope of the inventions as defined by the appended claims.

1. A medical data management system wherein patients, doctors, medical professionals except doctors, and medical institutions are registered as members, and log in using an ID and login authentication means for each member to register and preserve medical data for effective use thereof, the system comprising:
a management file associated with each individual medical data, in which access authority of a member to enable the member to access the medical data is recorded; and
access authority addition authentication means to enable recording additionally access authority of a member in the management file,
wherein the access authority addition authentication means exists for each patient member.

2. The medical data management system according to claim 1, which allows another member to access to medical data by a function for a member having his access authority already recorded in the management file of the medical data to add access authority of the another member to the management file.

3. The medical data management system according to claim 1, which is configured to have a function to enable each patient member to register his own medical data by himself and a function to record automatically each patient member's own access authority in the management files of all his medical data including medical data registered by other members, if any, such that each patient member can not only always access his own medical data but also disclose the medical data to others.

4. The medical data management system according to claim 1, which allows a researcher member to participate and is configured to have a function to record the scope of medical data approved by a patient member in the management file of the medical data so as to open medical data of the approved scope to the researcher member.

5. The medical data management system according to claim 1, further comprising:
a section to determine a member to be responsible for storage of medical data depending on order of degrees to which the medical data is needed by the members whose access authority is recorded in its management file, and if the member responsible for storage abdicates that responsibility, to transfer that responsibility to a candidate for a next member responsible for storage, and if finally all members abdicate the storage responsibility, to delete the medical data.

6. The medical data management system according to claim 1, further comprising:
a section to search automatically for a member responsible for storage for each medical data and to calculate the total amount of stored medical data for each member; and
a section to enable charging for the calculated total amount.

7. The medical data management system according to claim 1, which is configured to enable each patient member to change the access authority addition authentication means so as to prevent a doctor member who diagnosed the patient member in the past from accessing medical data of the patient member without a restriction.

8. The medical data management system according to claim 1, further comprising:
a warning setting section for a patient member to set, for his own medical data designated by the patient member, such that, when another member adds authority of access to the medical data, the system warns the another member to the effect that his action will be notified to the patient member and after the action of the another member, records and notifies the action of the another member to the patient member.

9. The medical data management system according to claim 1, further comprising:
a section for a patient member to register disposable authentication means to allow only once another member to add authority of access to his medical data designated by the patient member,
wherein the system is configured to require another member trying to add authority of access to the medical data to input the disposable authentication means.
